(19) United States
(12) Patent Application Publication
(10) Pub. No.: US 2011/0246645 A1
(43) Pub. Date: Oct. 6, 2011

(54) PARTICIPANT RESPONSE SYSTEM AND METHOD

(75) Inventors: Paul Martin, Calgary (CA); Michael Boyle, (US); Douglas Blair Hill, (US)

(73) Assignee: SMART TECHNOLOGIES ULC, Calgary (CA)

(21) Appl. No.: 13/077,609

(22) Filed: Mar. 31, 2011

Related U.S. Application Data
(60) Provisional application No. 61/320,309, filed on Apr. 1, 2010.

(51) Int. Cl. G09B 7/00; G06F 15/173

(52) U.S. Cl. 709/224; 434/362

(57) ABSTRACT

A method of using an assessment in a participant response system having a plurality of response devices includes locking an assessment portion to be loaded to create a locked assessment portion; transmitting the locked assessment portion to each response device for storage in each response device; unlocking the assessment portion on each response device at a time prior to a scheduled start time thereby to enable access to the assessment portion; and starting the assessment portion on each response device at the scheduled start time.

### FIELD OF THE INVENTION

The present invention relates generally to participant response systems and in particular to a participant response system and method.

### BACKGROUND OF THE INVENTION

Participant response systems for enabling participants of an event to enter responses to posed questions, to vote on motions or the like are well known in the art and have wide applicability. For example, during a conference, seminar or the like, participants can be provided with handsets that enable the participants to respond to questions, or to vote on motions raised during the conference or seminar. In the entertainment field, audience members can be provided with handsets that enable the audience members to vote for entertainment programmes or sports events. These participant response systems are also applicable in the field of education. Participants can be provided with handsets that enable the participants to answer questions posed during lessons, tests or quizzes. Of significant advantage, these participant response systems provide immediate feedback to presenters, facilitators, entertainment programme producers, or event organizers.

Participant response systems may be categorized as either wired or wireless. In wired participant response systems, remote units used by participants to respond to posed questions or to vote on motions are typically physically connected to a local area network and communicate with a base or host computer. In wireless participant response systems, the remote units used by participants communicate with the host computer via wireless communication links. Whether wired or wireless, many different types of participant response systems have been considered.

U.S. Pat. No. 4,247,908 to Lockhart, Jr., et al. discloses a two-way communication system for use with a host computer that includes a control unit, a base station and multiple, hand-held, portable radio/data terminal units. The control unit interfaces directly with the host computer but uses a radio link to interface with the portable radio/data terminal units. Each portable radio/data terminal unit includes a two-way radio and a data terminal. The data terminal includes a keyboard for data entry and an LED display for readout of either received data or locally generated data. The host computer initiates communication through polling and/or selection of portable radio/data terminal units via the control unit. The control unit, in response to a “poll” from the host computer, answers by sending either a previously received message from a portable radio/data terminal unit, or if no message has been received, a “no message” response. Polling by the control unit is an invitation to the portable radio/data terminal units to send data to the control unit to be stored, grouped if necessary and sent on to the host computer. The control unit polls the portable radio/data terminal units by address in a particular sequence. The control unit transmits acknowledgements to the portable radio/data terminal units for received data on the next polling cycle.

U.S. Pat. No. 5,002,491 to Abrahamson, et al. discloses an interactive electronic classroom system for enabling facilitators to teach participants concepts and to receive immediate feedback regarding how well the participants have learned the taught concepts. Structure is provided for enabling participants to proceed in lockstep or at their own pace through exercises and quizzes, responding electronically to questions asked, the facilitator being able to receive the responses, and to interpret a readout, in histogram or other graphic display form, of participant responses. The electronic classroom comprises a central computer and a plurality of participant computers, which range from simple devices to full fledged personal computers, connected to the central computer over a network. Optional peripheral hardware, such as video cassette recorders (VCRs) or other recording/reproducing devices, may be used to provide lessons to participants in association with the computer network.

U.S. Pat. No. 6,790,045 to Drimmer discloses a method and system for analyzing participant performance by classifying participant performance into discrete performance classifications associated with corresponding activities related to an electronic course. An observed participant performance level for at least one of the performance classifications is measured. A benchmark performance level or range is established for one or more of the performance classifications. It is then determined whether the observed participant performance level is compliant with the established benchmark performance level for the at least one performance classification. Instructive feedback is determined for the observed participant based upon any material deviation of the observed participant performance from at least one benchmark.

U.S. Patent Application Publication No. 2004/0072136 to Roschelle, et al. discloses a method and system for assessing a participant's understanding of a process that may unfold over time and space. The system comprises thin client devices in the form of wireless, hand-held, palm-sized computers that communicate with a host workstation. The system provides a sophisticated approach of directing participants to perform self-explanation, and enables instructors to enhance the value of this pedagogical process by providing meaningful and rapid feedback in a classroom setting.

U.S. Pat. No. 6,381,444 to Aggarwal, et al. describes a system for implementing a virtual class and distance education via a computer network. The process carried out by the system involves receiving signals from one or more instructor entities, the signals including lesson material designated as belonging to one or more interest groups. The lesson material is sent in advance to student entities listed in one or more of the interest groups to which the lesson material is designated as belonging. Signals from one or more student entities are received requesting admission to a particular class and instructions are sent to student entities to control the display and execution of the lesson material.

In the field of education, research shows that facilitators teach better and participants learn better when there is rapid feedback concerning the state of participants' comprehension or understanding. It is therefore not surprising that participant response systems are gaining acceptance in the field of education.

With the use of computers as response devices, educators such as teachers are able to compose content-rich assessments such as tests, quizzes exercises or activities and the like containing various multimedia contents, and transmit the assessments as files or groups of files to students' computers to facilitate learning. However, multimedia contents such as video clips can be large in size, and can accordingly take a long time to transmit from the teacher's computer to students' computers. As such, at the time a teacher wants to start an assessment, he/she and the students have to wait while the assessment is being transmitted to all of the response devices, before beginning. Significant time can be wasted simply waiting. In fact, in time-restricted cases, it may not be feasible to wait for the assessment loading to students' response devices. However, providing the assessment to the response devices in advance can create difficulty because the teacher can lose control as to when the assessment is to be started and completed by a student using a response device.

It is therefore an object of an aspect of the present invention to provide a novel participant response system and method.

### SUMMARY OF THE INVENTION

Accordingly, in one aspect there is provided method of using an assessment in a participant response system having a plurality of response devices, the method comprising locking an assessment portion to be loaded to create a locked assessment portion; transmitting the locked assessment portion to each response device for storage in each response device; unlocking the assessment portion on each response device at a time prior to a scheduled start time thereby to enable access to the assessment portion; and starting the assessment portion on each response device at the scheduled start time.

In another aspect there is provided a participant response system comprising at least one host computer having host processing structure configured to lock a portion of an assessment creating a locked assessment portion; and a plurality of response devices communicating with the at least one host computer, each of the response devices having response processing structure configured to receive the locked assessment portion, unlock the locked assessment portion at a time prior to a scheduled start time, and start the assessment portion at the scheduled start time.

The provided method and system enables preloading of assessments and assessment portions prior to the time at which they are required to be started thereby to occupy response device storage on demand and therefore efficiently, while inhibiting unauthorized and/or untimely access to the assessments and assessment portions.

### BRIEF DESCRIPTION OF THE DRAWINGS

Embodiments will now be described more fully with reference to the accompanying drawings in which:

FIG. 1 is a top plan view of a classroom employing a participant response system.

FIG. 2 is a schematic view of the participant response system of FIG. 1.

FIG. 3 is a schematic view of an interactive whiteboard forming part of the participant response system of FIGS. 1 and 2.

FIGS. 4A and 4B are side elevation and top plan views of a transceiver forming part of the participant response system of FIGS. 1 and 2.

FIG. 5 is a schematic block diagram of the transceiver of FIGS. 4A and 4B.

FIG. 6 is the schematic block diagram of the software structure.

FIG. 7 illustrates the assessment structure.

FIGS. 8A to 8D are the flowcharts of scheduling, preloading and starting assessments.

FIG. 9 shows the detailed steps of determining content to be transmitted.

FIGS. 10A to 10C show an exemplary file list used during determining content to be transmitted.

FIG. 11 illustrates the detailed steps of opening an assessment on target response devices.

FIGS. 12A to 12D are exemplary screens of the participant response system for the teacher to manage assessments.

FIGS. 13A to 13C are exemplary screens of the participant response system during the execution of an assessment.

FIG. 14 illustrates the detail of checking whether the available storage space on a response device is sufficient for loading an assessment according to a first alternative embodiment.

FIGS. 15A and 15B are the modified flowcharts for a second alternative embodiment.

FIG. 16 shows an exemplary screen according to a fourth alternative embodiment.

### DETAILED DESCRIPTION OF THE EMBODIMENTS

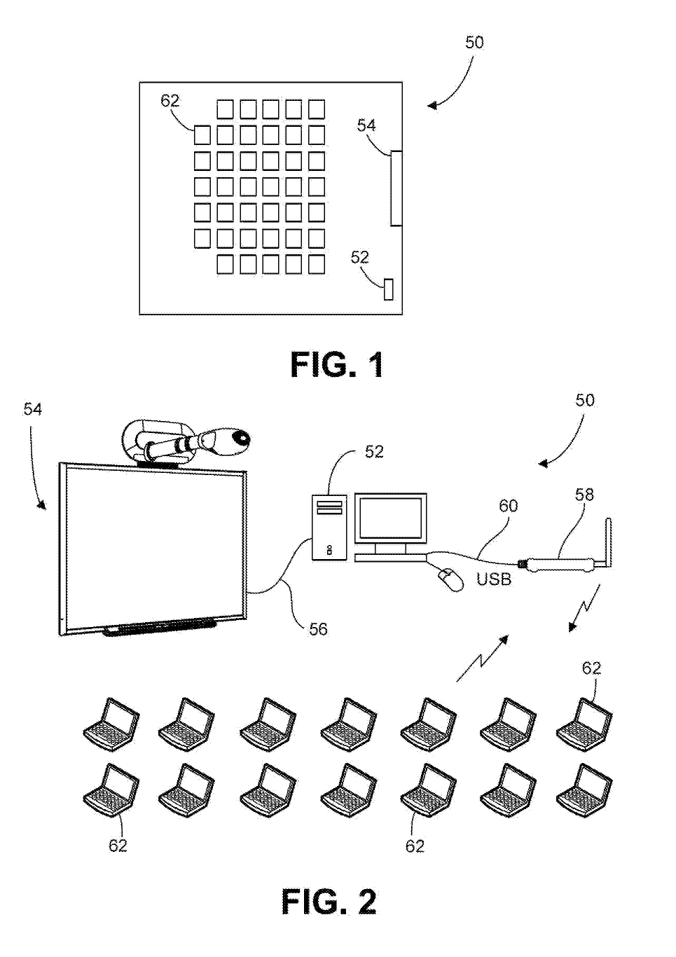

Turning now to FIGS. 1 and 2, a participant response system is shown and is generally identified by reference numeral 50. In this embodiment, participant response system 50 is employed in a classroom, lecture hall or theatre of an educational institution such as for example a school, university, college or the like and is used to create assessments, manage response devices, students and classes, transmit assessments to response devices, execute assessments, and analyze students' responses to the assessments. The participant response system 50 comprises a host computer 52, an interactive input system component, in this embodiment an interactive whiteboard (IWB) 54, connected to the host computer 52 via a cable 56, a radio frequency (RF) transceiver 58 connected to the host computer 52 via a universal serial bus (USB) cable 60, and a plurality of response devices 62 communicating with the host computer 52 wirelessly via the transceiver 58.

The host computer 52 is generally used by a teacher, and may be a desktop computer, laptop, personal digital assistant (PDA), or any other suitable computing device. The host computer 52 is identified by a unique ID, which may be the computer's medium access control (MAC) address or its network address. The host computer 52 may also connect to one or more servers (not shown) via the wired or wireless network (e.g., the local area network or Internet).

The response devices 62 may be desktop computers, laptops, PDAs, hand-held computing devices and/or other response devices having one or more control/processing units, storage, wired or wireless communication interfaces and one or more input device such as a keyboard. Each response device 62 also has a unique ID. At least some of the response devices 62 may also communicate with the host computer 52 via a wired connection, depending upon the nature of the implementation. Furthermore, at least some of the response devices 62 may be located at remote sites and may communicate with the host computer 52 via a network such as the Internet.

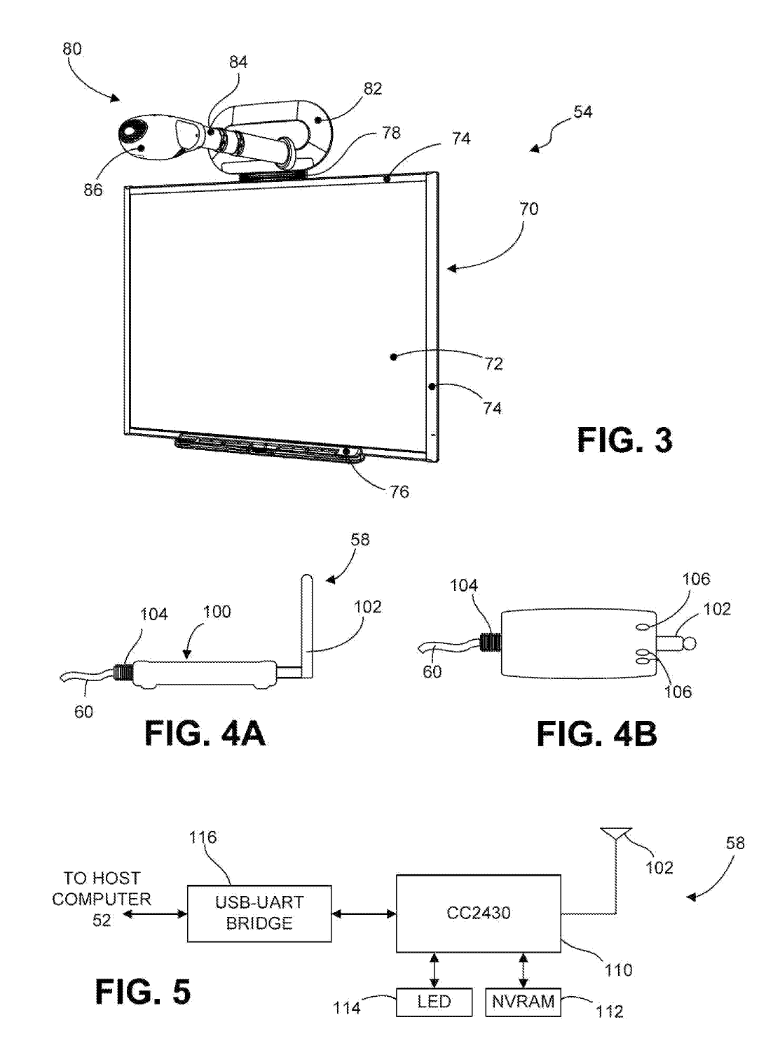

In this embodiment, the IWB 54 is a 600i series interactive whiteboard manufactured by SMART Technologies Inc., of Calgary, Alberta, Canada assignee of the subject application. As shown in FIG. 3, the IWB 54 comprises a large, analog resistive touch screen 70 having a touch surface 72. The touch surface 72 is surrounded by a bezel 74. A tool tray 76 is affixed to the bezel 74 adjacent the bottom edge of the touch surface 72 and accommodates one or more tools that are used to interact with the touch surface. The touch screen 70 is mounted on a wall surface via a mounting bracket 78. A boom assembly 80 is also mounted on the wall surface above the touch screen 70 via the mounting bracket 78. The boom assembly 80 comprises a speaker housing 82 accommodating a pair of speakers (not shown), a generally horizontal boom 84 extending outwardly from the speaker housing 82 and a projector 86 adjacent the distal end of the boom 84. The projector 86 is aimed back towards the touch screen 70 so that the image projected by the projector 86 is presented on the touch surface 72.

The host computer 52 runs SMART Notebook™ whiteboarding software offered by SMART Technologies ULC of Calgary, Alberta, Canada, to provide the teacher with a graphical user interface and to facilitate interaction with the IWB 54. With this configuration, the display output of the host computer 52 is conveyed to the IWB 54 and is used by the projector 86 to present an image on the touch surface 72. Pointer interactions with the touch surface 72 are detected by the touch screen 70 and conveyed to the host computer 52. The display output of the host computer 52 is in turn adjusted by the host computer to reflect the pointer activity. The host computer 52 and IWB 54 thus form a closed-loop. Depending on the nature of the pointer activity, the host computer 52 may treat the pointer contacts as writing or erasing or may treat the pointer contacts as mouse events and use the mouse events to control execution of application programs executed by the host computer 52. In this manner, the IWB 54 can be used by the instructor to create and administer tests and to analyze test results.

Turning now to FIGS. 4A, 4B and 5, the transceiver 58 is shown in further detail. The transceiver 58 comprises a casing 100 adapted to be desktop or wall mounted. An L-shaped omni-directional antenna 102 is mounted on the front end of the casing 100. The rear end of the casing 100 receives the USB cable 60 via the connector 104. A plurality of light emitting diodes (LEDs) 106 is provided on the top surface of the casing 100 with the LEDs being illuminated to provide visual feedback concerning the operational status of the transceiver 58. In this embodiment, the LEDs 106 comprise a power status LED and communications status LEDs. Alternatively, the transceiver 58 may provide visual feedback via a display such as a liquid crystal display (LCD) or via both LEDs and an LCD. The receiver electronics are accommodated by the casing 100 and comprise a microprocessor 110 that communicates with non-volatile, random access memory (NVRAM) 112, an LED driver 114 and a USB-UART bridge 116. In this embodiment, power is provided to the transceiver 58 via the USB connection. Depending on design requirements, commercial wireless transceivers such as wireless routers may also be used as the transceiver 58.

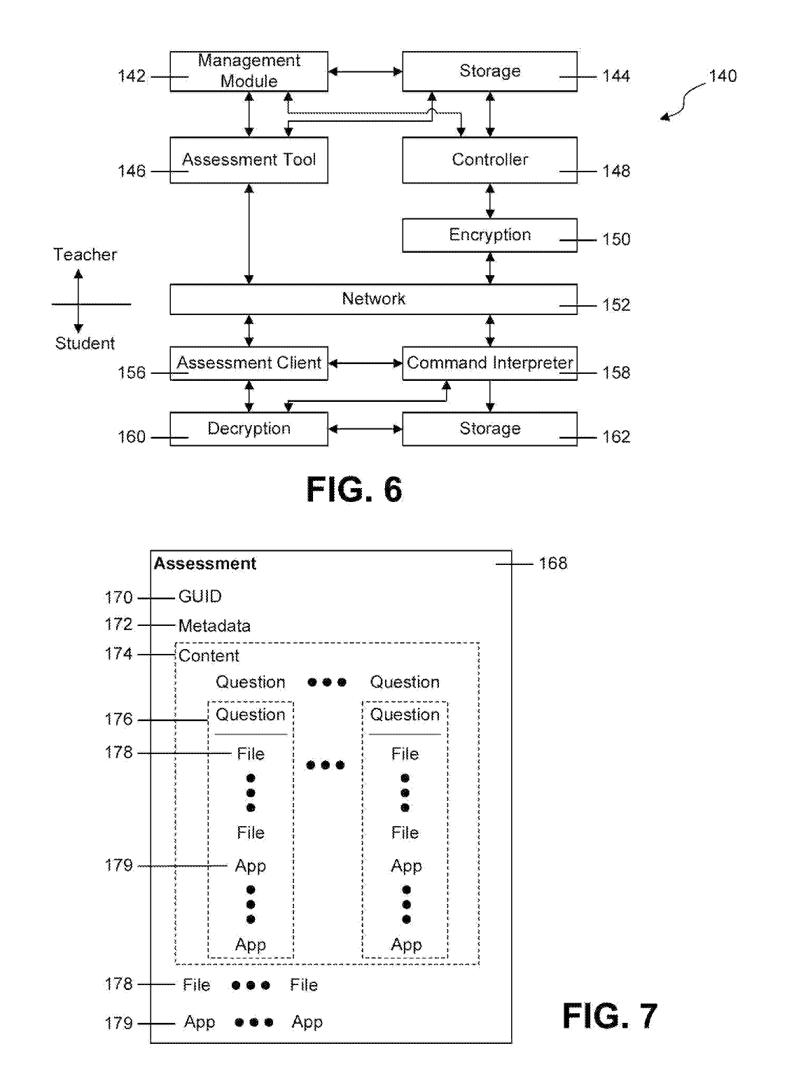

Turning now to FIG. 6, the software structure of a participant response system 140 is shown. The software structure has teacher-side modules and student-side modules, run with respective processing structures (not shown) and in communication via a network 152. On the teacher's side, the participant response system 140 has a management module 142, storage 144, an assessment tool 146, a controller 148, and an encryption module 150. In this embodiment, the modules on the teacher's side are stored and run on the teacher's computer, though alternatives are contemplated in which modules reside and run on one or more servers communicating with each other. On the student's side, the participant response system 140 has an assessment client 156, a command interpreter 158, a decryption module 160, and storage 162. The details of each module will now be described.

The storage at the teacher's side 144 and the storage at the student's side 162 may be by virtue of any computer readable medium such as for example, local or remote hard drives, floppy discs, rewritable optical discs (CD-R, DVD-R, DVD+R, DVD-RW, DVD+RW, DVD ROM), Flash drive, USB sticks, etc. and in which assessments may be stored as one or more files. As will be appreciated, different assessments may be stored in the same folder, or in different folders. Different assessments may share common files. The folder for storing each assessment may be manually specified. Alternatively, some or all folders for storing assessments may be automatically specified by the management module 142.

The management module 142 provides a graphical user interface (GUI) having various selectable functions for managing students, classes, response devices, and assessments. The assessment tool 146 provides a GUI having various selectable functions for creating/modifying assessments, starting an assessment, receiving student responses, and analyzing student responses. The assessment tool 146 interacts with the assessment client 156 during an assessment. In the exemplary embodiments described below, the assessment tool 146 is embodied in SMART Notebook™ software offered by SMART Technologies ULC of Calgary, Alberta, Canada, an instance of which is residing and running on the teacher's computer, and the assessment client 156 is embodied in SMART Notebook™ Student Edition software offered by SMART Technologies ULC of Calgary, Alberta, Canada, a respective instance of which is residing and running on each of the response devices 62. Other configurations of the assessment tool 146 and the assessment client 156 are contemplated. For example, some or all of the modules described above may reside and run on one or more servers, and communicate to each other via a network. As another example, the assessment tool 146 and/or the management module 142 may be implemented as web applications running on one or more servers, and may provide GUIs to the teacher via a web browser on the teacher's computer. The assessment client 156 may be a web application that runs on one or more servers, and that provides a GUI to each student via a web browser on each student's response device. In such a configuration, assessments are downloaded to the local storage 162 prior to the start (i.e., execution) of the assessments, and the assessment client 156 comprises a local web server which loads the content of the assessment from the local storage 162 for execution.

Controller 148 interacts with the command interpreter 158 for scheduling and controlling the assessment transmission and execution. In this embodiment, the encryption module 150 encrypts assessments before transmission, and the decryption module 160 decrypts assessments before the assessments are to be started.

The management module 142 manages the students and their access to the response devices 62. The management module 142 also allows the teacher or system administrator to set up named or anonymous classes. An anonymous class does not require names of any students before the class is scheduled to begin, though it may have assigned response devices 62. In this case, a student may use any assigned response device 62 or in some cases, any response device 62, to anonymously join a class.

A named class is a class that has student names and/or response devices 62 associated with it prior to its start. A named class may exist in the participant response system 140 for a period of time (e.g., a semester) or until the teacher deletes it. When the teacher adds students and/or response devices 62 to a class, the management module 142 associates a respective student ID and/or a respective response device ID to the class ID. In a named class, students are required to log into the class.

The teacher may designate the association of students and response devices 62 in a class. The participant response system 140 supports various associations between classes, students and response devices 62. Some examples of the various associations are: a student may have access to multiple response devices 62 in different classes; a response device 62 may be accessible by multiple students in a class, or by multiple students in different classes; a response device 62 may be always associated with a particular class and always associated with a particular student in that class; a response device 62 may be associated with multiple classes and for each of the multiple classes that response device 62 may be associated with a particular student; a response device 62 may be always associated with a particular class but not associated with any particular student; a response device 62 may be shared by multiple students in a class where all students sharing the response device need to log in together. Different combinations of associations are also available. For example, in a particular class some response devices 62 may be associated only with a respective student, whereas other response devices 62 may not be so restricted, and therefore be accessible to all students. The associations may be established permanently, or for a set period of time (e.g., a semester). The associations may also be established to allow students to gain access to the response device 62 outside of class time to work on homework, etc.

Similar to how the management module 142 supports associations between the students, classes, and response devices 62 (described above), the management module 142 also supports associations between the classes, teachers, and host computers 52.

The participant response system 140 provides the teacher with an assessment tool 146 to create assessments to be completed by the students. The assessments may be manually started by the teacher (ad-hoc) or automatically started at a time selected by the teacher (scheduled), as will now be described.

The teacher begins creating an ad-hoc assessment by accessing the assessment tool 146 either directly, or through the management module 142. Alternatively, the teacher may load a previously-created ad-hoc assessment from the storage 144 into the assessment tool 146. Once the ad-hoc assessment is created or loaded into the assessment tool 146, the teacher initiates a command in the assessment tool 146 to start the assessment, and the content of the assessment is in response transmitted by the network module 152 from the assessment tool 146 to the assessment client 156 on each of the response devices 62 associated with that class. The assessment client 156 presents the assessment to the student through a GUI, accepts student responses, and transmits the student's responses through the network module 152 to the assessment tool 146. The assessment tool 146 communicates the student's responses to the management module 142, and the management module 142 assesses the student's responses to determine a grade for each student.

The teacher begins creating a scheduled assessment by accessing the assessment tool 146 either directly, or through the management module 142. Alternatively, the teacher may load a previously-created scheduled assessment from the storage 144 into the assessment tool 146, for modification for example. The created or modified assessment is then saved to storage 144. The management module 142 provides the teacher with tools to configure an assessment schedule and indicate a scheduled starting time for the scheduled assessment. Once the assessment schedule is set up, it is sent from the management module 142 to the controller 148. The controller 148 is responsible for preloading scheduled assessments onto each of the response devices 62 according to a preloading method, which will be described in further detail below. As will be appreciated, the scheduled assessments will be loaded from the storage 144 on the teacher's side and sent to the storage 162 on each of the response devices 62 on the student's side. When the transmission starts, the controller 148 retrieves the assessments from the storage 144 and encrypts its contents by calling the encryption module 150. The encrypted contents are then transmitted by the network module 152 to storage 162 on each of the response devices 62 on the student's side. The command interpreter 158 on each of the response devices 62 coordinates with the controller 148 on the teacher's side to receive the transmitted assessments and save them onto storage 162 on the response devices 62.

Shortly before the scheduled starting time for a scheduled assessment, the controller 148 calls on the assessment tool 146 and automatically loads the scheduled assessment from the storage 144 to the assessment tool 146. The controller 148 instructs the assessment tool 146 to start the scheduled assessment. Similarly, on each of the response devices 62, the command interpreter 158 calls the assessment client 156. The scheduled assessment is loaded from the storage 162 and is decrypted by the decryption module 160. The decrypted scheduled assessment is then loaded to the assessment client 156. The command interpreter 158 on each of the response devices 62 communicates through the network module 152 with the controller 148 and instructs the assessment client 156 to start the scheduled assessment.

During the execution of an assessment, the assessment tool 146 may send various commands to the assessment client 156 to automatically start an application (e.g., a calculator program), open a document file, play a video or audio clip, etc., on each of the response devices 62. The teacher may also set up a macro in the assessment to send a plurality of commands to the assessment client 156 to perform a function on the response device 62. For example, when a student working on an assessment reaches a math question, a macro can be set to automatically start a calculator program. The calculator program itself need not be a part of the assessment. The macro can start a timer for the question and record what numbers the student enters into the calculator. When the student finishes the question, the macro can automatically terminate the calculator application and save the recorded data (e.g., the student's answer to the question, the time taken by the student to answer the question, and the sequence of calculator keys pressed by the student to answer the question) in one or more files. Such file(s) can also be sent to the teacher's computer for review by the teacher. Also, if an auto-marking option in system settings is enabled, the assessment tool 146 may automatically mark the student answers. In some embodiments, a student's answer is given a higher mark if the question was answered faster.

Turning now to FIG. 7, the structure of an assessment 168 is shown. In this embodiment, each assessment 168 is a SMART Notebook™ file. Each assessment 168 is assigned a globally unique identifier (GUID) 170, and contains a set of metadata 172, and content 174. If required, an assessment 168 may contain one or more files 178 and application indicators 179.

The metadata 172 contains information useful for identifying the assessment 168. Exemplary information contained in metadata 172 includes grade level, subject, topic, type (e.g., quiz, exam, homework, etc.), keywords, date created, last modification date, author, etc. The content 174 contains the material useful to the student for completing the assessment 168. The content 174 may include one or more questions 176 to be answered by the students. Different question types may be employed, for example, true/false questions, yes/no questions, multiple choice questions, numerical and math questions, short-answer questions, essay questions, etc. Each question contains a unique question ID as well as text, math equations and/or images. As will be appreciated, where appropriate (for example, for a true/false question), a question will have a corresponding answer containing a unique answer ID and text. The answer may also contain one or more images, files 178 and/or application indicators 179.

Each file 178 may be a text file, audio/video clip, software program file, or any other type of file a teacher may use in conjunction with an assessment or in conjunction with one or more questions of an assessment. As will be appreciated, a file 178 may be in compressed form such as for example a zip package comprising a plurality of files, or an executable software program package that, after running, extracts or installs a plurality of program files to storage 162, or may contain a link to a specific file location or internet web page. A file 178 may be an upgrade or downgrade software package or plug-in of one or more software applications to ensure the response device 62 has the most relevant version of the software applications installed as required by the assessment 168. For example, in the case that the assessment 168 contains a file 178 in the form of a video file, a second file can be attached to the assessment 168 to ensure the video player on the response device 62 is up-to-date to play the video file.

A file 178 may be embedded in or linked to an assessment 168 at a designated location. For example, a file 178 may be embedded in or linked to an assessment 168 at a location between the second and third questions, so that a student will see the file 178 after she answered the second question and before she encounters the third question. Moreover, a file may be embedded in or linked to a specific question in the assessment 168. Each file 178 has a set of properties associating it to the assessment 168. For example, each file 178 can have an associated assessment GUID, associated question ID, file name, file path, file size, date created, last modification date, starting condition, ending condition, optional flag, etc. The associated question ID indicates the question a file 178 is associated with. However, if a file 178 has an associated question ID that is set to NULL, the file 178 is associated with the assessment 168, and not any particular question in the assessment. A starting condition can be set so the file 178 is opened or executed at a particular time, for example, when the student begins the assessment or when the student reaches a particular question. The ending condition can be set so the file 178 is closed or execution is stopped running at a particular time, for example, when the student submits an answer for a question associated to that file 178. A file 178 with the “optional” flag cleared must be successfully transmitted to the response devices 62. that is, if the “optional” flag is set, the file is optional, and thus does not need to be transmitted to a response device if the device does not have enough storage for the file, or if there is not enough time to transmit it to the response devices before the assessment starts. Also, if the transmission of an optional file (i.e., a file with the “optional” flag being set) failed, it would not be retransmitted.

An application indicator 179 indicates an application already installed on the response device that should be run at a designated time during the assessment. It is embedded at the designated position of the assessment file, or in a question of the assessment. Each application indicator 179 has a set of properties such as for example associated assessment GUID, associated question ID, application ID, date created, last modification date, and a starting time. If the associated question ID field is NULL, the application indicator is associated with the assessment (i.e., is not associated with any question in the assessment); otherwise, the application indicator is associated with the question indicated by the associated question ID field. The application indicated by the application indicator 179 will automatically run at the starting time unless its starting time is empty. An empty starting time means that the student must click a link presented at the designated position of the assessment to manually start the application. When the assessment is loaded to a response device, the system will check whether the response device has installed the application indicated by the application indicator 179. If not, the system will transmit the application to the response device and install it therein.

A preloading method used by the participant response system 140 for preloading the assessments onto each of the response devices 62 will now be described. This method enables the participant response system to schedule assessments at the starting time set up by the teacher, and preload the scheduled assessments to response devices 62 prior to the start of the assessments. Furthermore, the preloaded assessments are stored in the storage 162 of the response devices in a locked form. That is, locked preloaded assessments cannot be accessed by unauthorized users, and cannot be accessed by authorized users until unlocking under predefined conditions to allow the response users access only shortly before or at the time the assessment is to start, while the other assessments remain locked. Furthermore, a used assessment may be deleted, or may be kept in the storage 162 of the response devices (in a form that allows authorized users to access it, but does not allow unauthorized users to access it) for future use.

The management module 142 maintains a table of assessment schedules. Each record of the table comprises the GUID of a scheduled assessment, its starting time, the classes assigned to it, and a “Delete after use” flag indicating whether the assessment should be deleted after the assessment has been completed or if it should remain in the storage 162 of the response device 62 in, for example, an encrypted and/or compressed form.

The management module 142 also maintains an assessment-computer map indicating the status of assessments and files currently stored in each of the response devices 62. In this embodiment, the assessment-computer map comprises the fields of response device ID, assessment GUID, File ID, “Transmitted” flag, transmission date/time, “Used” flag, and usage date/time. Other fields that may also be employed include question ID, question type, etc. The assessment-computer map can be used to check whether an assessment or file has been transmitted to a response device 62, whether an assessment or file has been used, what device ID's contain the assessment or file, etc. For example, a record in the assessment-computer map showing a file having a “Transmitted” flag with a value of FALSE indicates that the file has not been transmitted. Once an assessment or file has been deleted from the response devices, it is no longer listed on the assessment-computer map.

Any assessments or files that are saved in the storage 144 of the host computer 52 to be transmitted to the response devices 62, will be indicated on the assessment-computer map as having a value in the transmission date/time field indicating the loading date and time, which is the data and time that the assessment transmission is to start, as will be described in more detail below. For assessments that have been transmitted to the response devices 62, the transmission date/time is the date and time the assessment transmission actually started. For assessments to be started, the field usage date/time is the scheduled starting date and time of the assessment. For assessments that have already been used, the usage date/time is the date/time the assessment actually started.

The assessment-computer map is designed as above to minimize the file transmission from the storage 144 at the teacher's side to storage 162 of each response device 62. For example, if an assessment to be transmitted comprises a file shared with an assessment that has already been transmitted to and stored in the storage 162 of each response device 62, then this file does not need to be transmitted again. However, it will be appreciated that the assessment-computer map may be designed such that it does not include the file ID field. In this case, all files of an assessment to be transmitted will be transmitted.

The assessment-computer map is updated when a new assessment is added to the schedule. It is also updated when a scheduled assessment is modified (e.g., when the assessment content is modified, or when a new file is added into or a file is deleted from a scheduled assessment), when the schedule of an assessment is changed, when an assessment is transmitted to response devices 62, when an assessment completes its execution, or when the students (or response devices) in the class are changed (e.g., adding new students/response devices 62 into or removing some students/response devices 62 from the class). The system monitors the status of the files listed in the map. The map is updated when a listed file is modified.

The management module 142 provides the teacher with a GUI (not shown) for managing response devices 62, students and classes. When, for example, adding a new response device R1 to a class C1, the teacher uses this GUI to input the response device ID, the class ID and the date/time the response device starts (or will start) to be used in the class C1. Then, the management module 142 notifies the controller 148 to update the assessment-computer map so that all the assessments scheduled to the class C1 will be transmitted to the response device R1. Similarly, if a response device R2 is removed from a class C2, the assessment-computer map will also be updated so that the assessments scheduled to the class C2 will not be transmitted to the response device R2.

With the above-described design, an assessment or a file may correspond to multiple records in the assessment-computer map. For example, the same assessment scheduled to different classes may correspond to different record sets in the map. The same file scheduled to the same response device that is included in different classes (i.e., used in different classes at different time) corresponds to different records in the map. However, each record in the map corresponds to a unique file-class-response device (or file-class-student) relationship. The system uses this map to determine whether a file or an assessment needs to be transmitted to a response device 62.

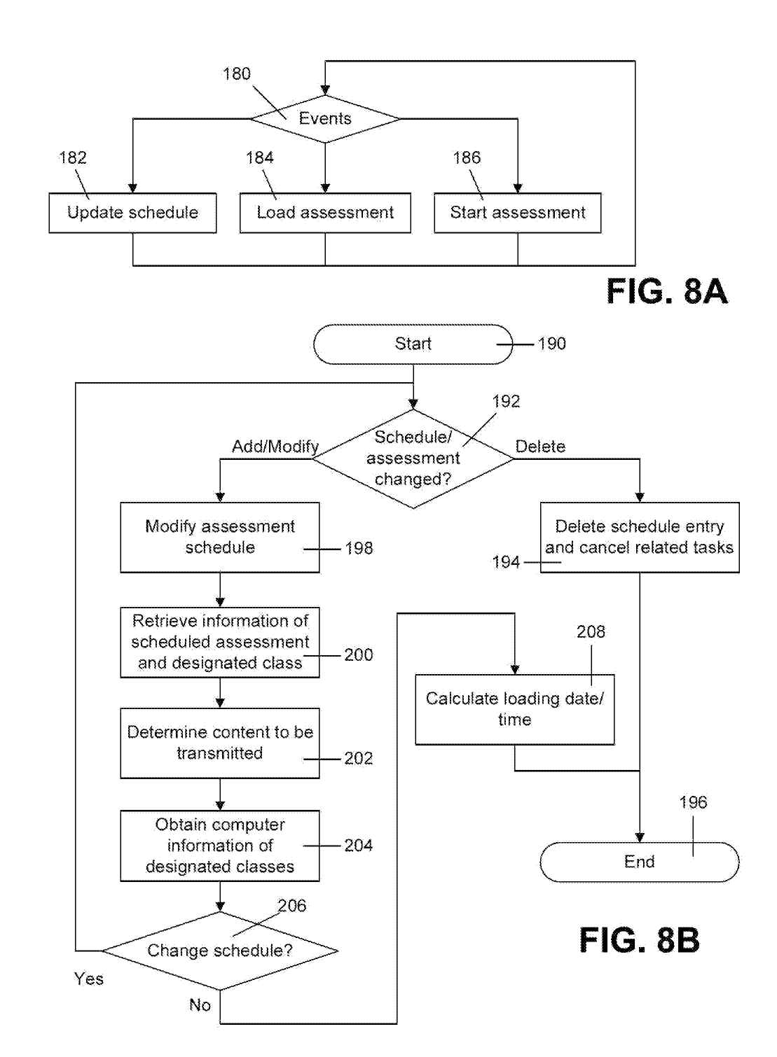

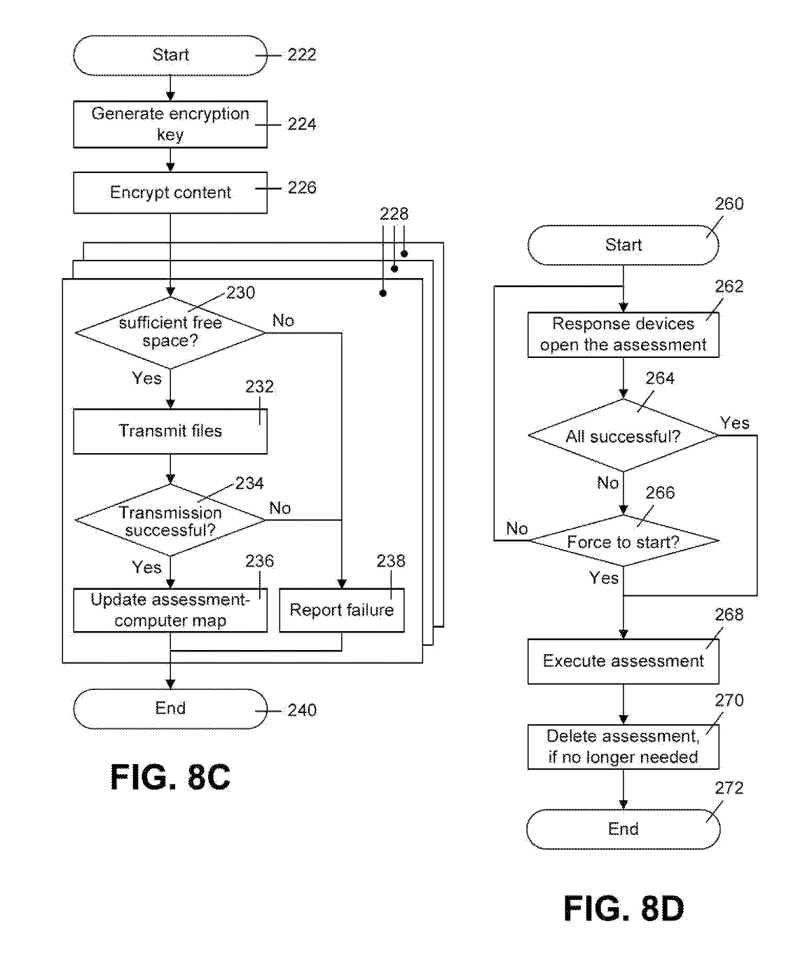

Turning now to FIG. 8a, the process of the preloading method is shown. As can be seen, the process is event driven. The process begins when an event is received (step 180). The controller 148 checks the event and in response, updates the assessment schedule accordingly (step 182), loads the assessment (step 184), or starts an assessment (step 186). As will be appreciated, the process is a continuous loop and thus, once an event has been handled, the process waits for a new event. In a multi-tasking environment, different events may be processed in parallel.

Turning now to FIG. 8b, the method of updating the assessment schedule (step 182) is shown in more detail. When the controller 148 determines that the event requires the assessment schedule to be updated, which may be triggered when the teacher adds, modifies, deletes an assessment schedule entry, modifies the content of a scheduled assessment or deletes a scheduled assessment, the process begins (step 190).

In the event that the teacher deletes an assessment entry or a scheduled assessment (step 192), the controller 148 deletes the assessment schedule entry and cancels all related tasks (step 194). The method of updating the assessment schedule is then complete (step 196), and the controller 148 returns to step 180 (see FIG. 8a) and waits for a new event.

In the event that the teacher added a new scheduled assessment, or modified an existing schedule entry or scheduled assessment, the controller 148 modifies the assessment schedule accordingly to add a new entry or revises the corresponding entry (step 198). The controller 148 retrieves the information of the scheduled assessment and the designated classes (step 200). The retrieved information of the scheduled assessment includes, for example, the start date/time of the assessment, the files associated with the assessment, the size of each file, and the “optional” flag for each file. The information of the designated class includes, for example, the students and response devices 62 assigned to that class, as well as the association between the students and the response devices 62.

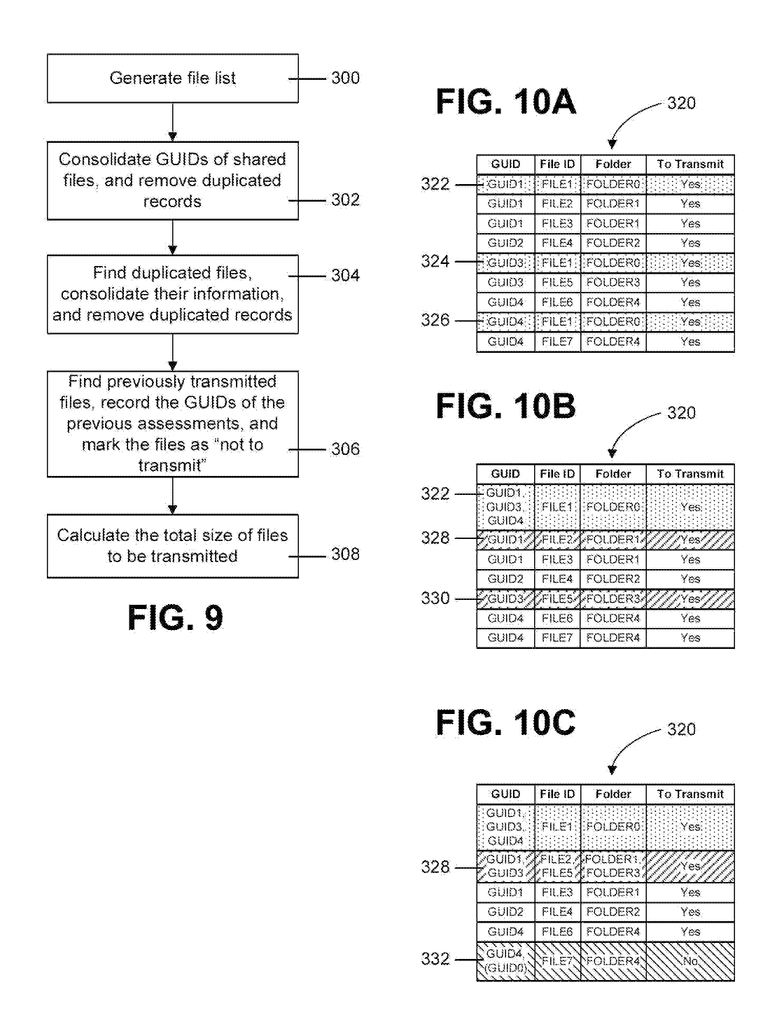

In step 202, the controller 148 uses the retrieved information to determine the content to be transmitted to the response devices 62, the details of which will now be described with reference to FIG. 9. As shown, a file list is generated (step 300) identifying all files to be transmitted to the response devices 62. An exemplary file list 320 is shown in FIG. 10a. In this embodiment, the file list 320 contains the following fields: the loading date/time (not shown), assessment GUID, file ID, Folder, and a flag “To Transmit”. The “To Transmit” flag can have a “YES” or “NO” value, indicating whether or not a file needs to be transmitted. The file list 320 is generated in step 300 with the “To Transmit” flag of all files in the list set to the value of “YES”. As will be appreciated, the file list 320 may contain other fields such as question ID, file size, file name, file creation date, last modification date, author, etc. Although the loading date/time is not shown, the files in file list 320 are sorted according to loading date/time, the files having an earlier loading date/time being at the top.

In step 302, the file list 320 is reduced by consolidating the records having the same file. In the example shown in FIGS. 10a to 10c, records having the same file ID are identified as records having the same file. In some alternative embodiments, records having the same file name and folder are identified as records having the same file. In yet some alternative embodiments, records having the same file ID and folder are identified as the records having the same file. The assessment GUID's of each group of identified records are merged into the record having the earliest loading date/time in the group, and other records in the group are deleted. For example, in FIG. 10a, records 322, 324 and 326 have the same file FILE1, where the record 322 has the earliest loading date/time in the group. Since there is no need to send the same file three times, records 324 and 326 are consolidated with record 322, as shown in FIG. 10b. The consolidated record 322 comprises the assessment GUID's: GUID1, GUID2 and GUID3. Accordingly, records 324 and 326 are deleted from the file list 320.

In step 304, the system searches for duplicate files that may not have the same file ID, file name and/or folder, but contain the same content. Files having the same content can be identified by comparing the content, performing a cyclic redundancy check (CRC), or comparing other characteristics of the files. The information of the duplicated files is consolidated, and the duplicate records are deleted. In this embodiment, step 304 is completed by comparing the content of all the files in file list 320. As shown in FIG. 10b, files FILE2 (record 328) and FILE5 (record 330) are found to be the same, among which the record 328 has the earliest loading date/time. The fields of record 330 are then merged into the fields of record 328, and record 330 is removed from the file list 320, as shown in FIG. 10c. In some alternative embodiments, step 304 may be optional.

In step 306, the controller 148 searches the assessment-computer map to identify files in the file list 320 that have been previously transmitted to the response devices 62. For each identified file in the file list 320, the last modification date/time is compared with the transmission date/time. If the transmission date/time is earlier than the last modification date/time, the “To Transmit” flag remains “YES”. If the transmission date/time is not earlier than the last modification date/time, the “To Transmit” flag is cleared, and the assessment GUID of the identified file in the assessment-computer map is recorded. For example, as shown in FIG. 10c, it is found that FILE7 (record 332) had been previously transmitted with the assessment GUID0. The transmission date/time is later than the last modification date/time (not shown). Accordingly, GUID0 is recorded in the GUID field of record 332, and the “To Transmit” flag of record 332 is cleared (its value is changed to “NO”). In some alternative embodiments, step 306 may be optional.

The above example only shows the files associated with the assessments. Those skilled in the art will appreciate that files associated with questions can also be consolidated in a similar manner.

In step 308, the total size of all files in the list is calculated. Similarly, the total size of all necessary files (that is, all files with the “optional” flag cleared) is also calculated.

Turning back to FIG. 8b, the controller 148 queries the response devices 62 associated to the designated class to obtain information regarding the size of available storage for each of the response devices 62, the overall network type and the overall network speed (step 204). The controller 148 uses this information along with the size of the files to be transmitted to estimate the transmission information such as the time needed to transmit the assessments, whether any of the response devices 62 do not have sufficient storage space to receive the scheduled assessments, etc. The controller 148 then presents a set of recommendations, warnings and alerts to the teacher for scheduling the transmission of the assessments. As an example, a warning is presented to the teacher if any of the response devices 62 do not have sufficient storage space to receive the scheduled assessments. A warning may also be presented to the teacher if any of the response devices 62 does not have enough storage space for the necessary files (i.e., files with the “optional” flag cleared) of the scheduled assessment. Similarly, a warning could be presented to the teacher indicating that there is not enough time to transmit the scheduled assessments to each of the response devices 62 before they are to be used, and thus recommends rescheduling the assessment to ensure enough time is available for assessment transmission.

In step 206, the controller 148 allows the teacher to make further updates to the assessment schedule. If the teacher decides to make further updates to the assessment schedule, the process returns to step 192. In the event the teacher decides not to make any more changes to the assessment schedule, the controller 148 calculates the loading date/time D_{T} (step 208) for the assessment to be transmitted to each of the response devices 62. If the teacher set the assessment to start immediately, the loading date/time D_{T} is then the current date/time. If the teacher set the assessment to start in a future time, the loading date/time is calculated as shown in Equation 1, below:

D_{T}=D_{A}−T₀ (1)

where:

D_{A} is the starting date/time of the assessment; and

T₀ is the transmission overhead calculated by the system or defined by the teacher.

The method of updating the assessment schedule is then complete (step 196), and the controller 148 returns to the preloading method and waits for a new event.

Turning now to FIG. 8c, the method of loading the assessment (step 184) is shown in more detail. The method begins at the loading date/time D_{T} of the scheduled assessment (step 222). The controller 148 calls on the encryption module 150 and generates a unique encryption key for the scheduled assessment to be transmitted (step 224). The scheduled assessment and its associated files are encrypted using the unique encryption key (step 226). As will be appreciated, the scheduled assessment and its associated files may be encrypted and stored individually, or may be encrypted and stored as a single file. Digital signatures and/or integrity check data (for example, CRC, MD5) may also be added to the files. At this step, the consolidated file list 320 and the schedule are also encrypted.

Depending on the cryptographic scheme the system uses, the decryption key may or may not be the same as the encryption key. In a preferred embodiment, public key infrastructure (e.g., Pretty Good Privacy (PGP) programs) is used, and the decryption key is different from the encryption key.

The controller 148 transmits the encrypted scheduled assessment to all response devices 62 associated with the scheduled class (step 228). The system first checks whether each of the response devices 62 has sufficient storage space available for receiving the necessary files (i.e., files with the “optional” flag cleared) of the scheduled assessment (step 230). If a response device 62 does not have sufficient storage space, the command interpreter 158 reports to the controller 148 that the preloading failed because of insufficient free space (step 238). If the response device 62 does have sufficient storage space, the controller 148 transmits the encrypted scheduled assessment and its associated files from storage 144 to the response device 62, where it is saved in storage 162 (step 232). In this embodiment, the encrypted consolidate file list 320 is first transmitted to the response device 62, so the command interpreter 158 can properly generate files for the scheduled assessment to be transmitted. The encrypted schedule is then transmitted to the response device 62 to update the command interpreter 158. The decryption key of each scheduled assessment is not transmitted at this step. The encrypted scheduled assessment is then transmitted to the response device 62. Necessary files, that is, files with the “optional” flag cleared, are transmitted first.

During the transmission (step 232), the controller 148 monitors the transmission and the consumption of the storage 162 of the response device 62. If the transmission of a necessary file failed, the controller 148 will prompt for the retransmission of the necessary file for a predefined number of times. Once the necessary files have been sent, the controller 148 transmits the optional files, that is, the files with the “optional” flag set to “YES”. If any of the optional files cannot be successfully transmitted, the controller 148 sends the host computer 52 an error message. The transmission error of an optional file is not considered to be a transmission failure.

In step 234, controller 148 determines if the transmission has been successful (step 234). In the event that not all necessary files were transmitted to the response device 62, the command interpreter 158 on the response device reports the failure to controller 148 (step 238). Loading the scheduled assessment is then complete (step 240), and the controller 148 returns to the preloading method and waits for a new event. In the event that all necessary files have been successfully transmitted to the response device 62 (step 236), the system updates the assessment-computer map to record the response device ID, the assessment ID and the file ID. The “Transmitted” flag is set to “YES”, and the “Used” flag is cleared (step 236). The method of loading the scheduled assessment is then complete (step 240), and the controller 148 returns to the preloading method and waits for a new event.

As will be appreciated, in the event that the transmission of all scheduled assessments and their associated files was successful (step 234), the files are saved on the storage 162 of each of the response devices 62 in encrypted form, which prevents unauthorized access to the content of the scheduled assessments. Each scheduled assessment will be individually decrypted at a predetermined time prior to the time the assessment is to be used, as will now be described.

Turning now to FIG. 8d, the method of starting a scheduled or ad-hoc assessment (step 186 in FIG. 8a) is shown in more detail. The method begins when the teacher manually starts an ad-hoc or scheduled assessment, or when the scheduled decryption time of a scheduled assessment is reached (step 260). The decryption time is calculated from the scheduled starting time of an assessment time as shown in Equation 2, below:

D_{d}=D_{A}−T₁ (2)

where:

D_{d} is the decryption date/time of an assessment;

D_{A} is the starting date/time of the assessment; and

T₁ is the decryption overhead determined by the system based on the performance of the response device and the size of the assessment.

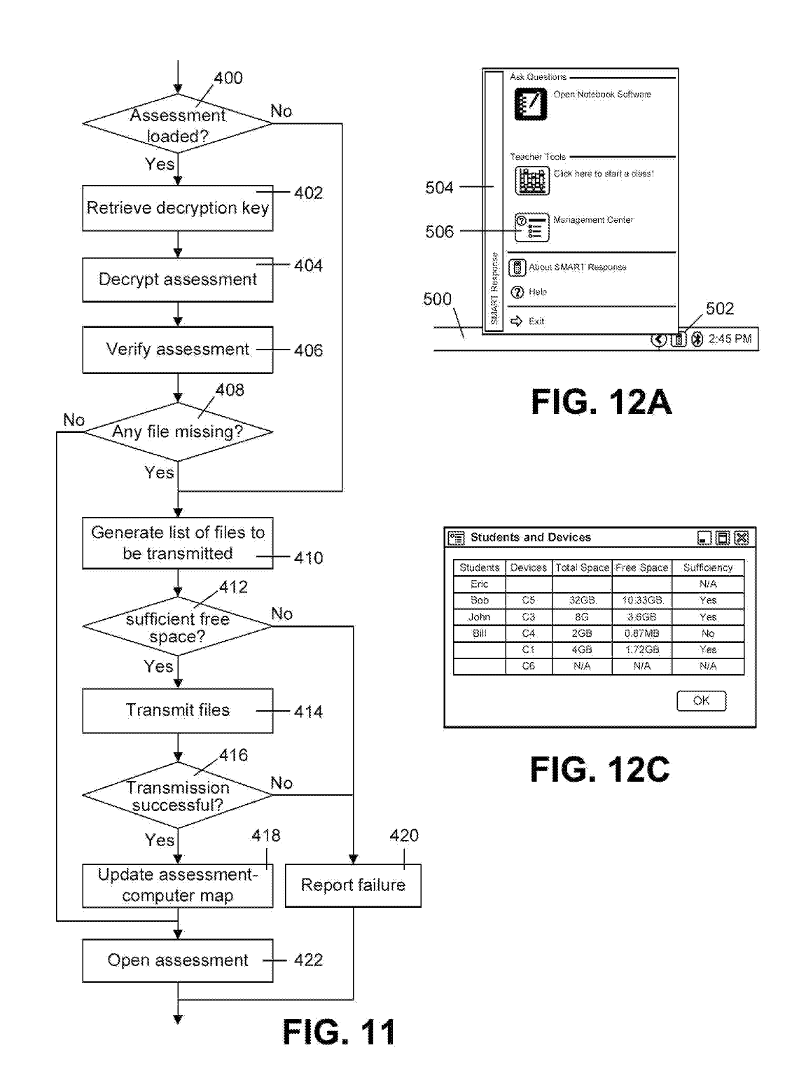

Each of the response devices 62 associated to the class opens the assessment to be executed (step 262), as will now be described with reference to FIG. 11.

In step 400, each of the response devices 62 checks whether the assessment has been successfully preloaded into storage 162. In the event that a response device 62 has determined that the assessment has not been preloaded into storage 162, such as, for example, in the event that an ad-hoc assessment is manually loaded by the teacher, the method skips to step 410. In the event that a response device 62 has determined that the assessment has been preloaded into storage 162, the command interpreter 158 of the response device 62 retrieves the decryption key for that particular assessment from the controller 148 (step 402). The assessment is then decrypted using the decryption module 160 of the response device 62 and the decryption key (step 404). The command interpreter 158 verifies the assessment and its associated files to see if any files are missing (step 406). In the event that it is found that no files are missing, the method skips to step 422. In the event that it is found that at least one file is missing, a list of files that have not been successfully loaded to the response device 62 is generated (step 410). A check is made regarding whether the response device 62 has sufficient storage space for receiving the files to be transmitted (step 412).

If the storage space is insufficient, the response device 62 reports a failure (step 420), and the controller 148 returns to method step 264 of FIG. 8d.

If the storage space is sufficient, the files are transmitted from storage 144 through the network 152 to storage 162 of the response device 62 (step 414). Similar to that described above, retransmission may be used if transmission errors occur. If the file transmission is not successful (step 416), the response device 62 reports transmission failure (step 420), and the controller returns to method step 264 of FIG. 8d. If the file transmission is successful (step 416), the controller 148 updates the assessment-computer map to record the response device ID, the assessment ID and the file ID. The “Transmitted” flag is set to “YES”, and the “Used” flag is cleared (step 418). The assessment client 156 of the response device 62 opens the assessment (422) and the process then goes to step 264 of FIG. 8d.

Returning to the method of starting the assessment in FIG. 8d, the controller 148 checks to ensure all response devices 62 are successful in opening the assessment (step 264). In the event that all response devices 62 are successful, the command interpreter on each of the response devices 62 instructs the assessment client 156 to begin the assessment. In the event that not all response devices 62 have successfully opened the assessment, the controller 148 alerts the teacher with the reasons of failure through the host computer 52, and waits for the teacher to decide whether or not to start the assessment without waiting for all response devices 62 to open the assessment (step 266). In the event that the teacher chooses to wait for all response devices, the method returns to step 262 and waits for all response devices 62 to open the assessment. In the event that a response device 62 does not have sufficient storage space to receive the assessment, the teacher and/or student may delete some files from the storage 162 of that response device 62, to clear up space for the assessment. In the event that the teacher decides to continue the assessment without waiting for all response devices 62 to open the assessment, the method continues to step 268.

In step 268, the controller 148 calls on the assessment client 156 to display a cover page of the assessment to the student through a display of the response device 62. The controller 148 will lock the display of each of the response devices 62 that have successfully opened the assessment until the scheduled starting time of the assessment is reached or the teacher has decided to force the assessment start. The assessment tool 146 communicates over the network 152 with the assessment client 156 on each of the response devices 62 to execute the assessment. In this embodiment, each student will answer questions on the response device 62, and the assessment tool 146 records the student's responses. Once the assessment is complete, each response device 62 checks the “Delete after use” flag, and deletes the assessment as well as its associated files from the storage 162 if the flag is set to “Yes” (step 270). Once the assessment is removed, the command interpreter 158 notifies the controller 148 over the network 152, which notifies the management module 142 to update the assessment-computer map by removing the deleted assessment. The method of starting the assessment is then complete (step 272), and the controller 148 returns to the preloading method and waits for a new event.

With the preloading and decryption method described above, the command interpreter 158 only unlocks (via decrypting) the assessment that will start in a short time. However, other assessments are still locked as they are stored in an encrypted form on the storage 162 until their respective starting times or shortly beforehand. In this manner, waiting for assessment downloading to the response system is avoided, while the assessments are protected from access before their respective start times.

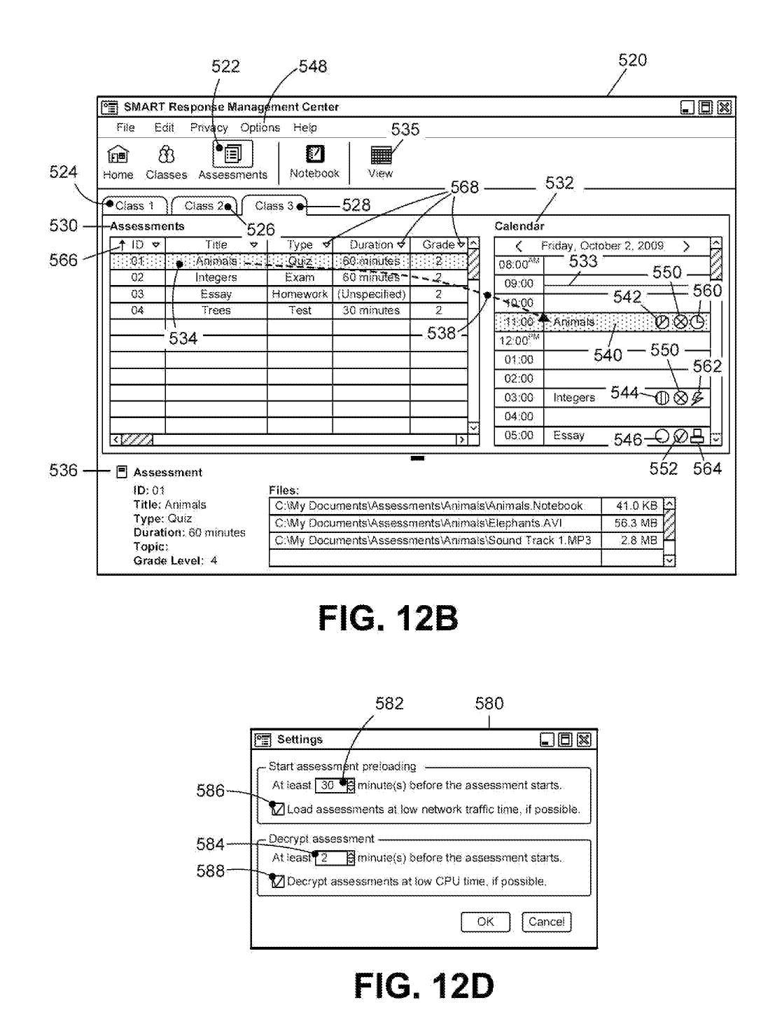

FIG. 12a shows an embodiment of the host computer 52 running the participant response system 140 in a Microsoft Windows XP environment. In this embodiment, when the response system 140 is running, an icon 502 is added to the task bar 500. When the teacher clicks on the icon 502, a menu 504 is loaded. When the teacher selects the management center 506, the SMART Response Management center is loaded to allow the teacher to perform various management tasks.

FIG. 12b shows an exemplary window 520 of the SMART Response Management Center, where the teacher has selected the assessments icon 522 to schedule assessments. As can be seen, each class is identified by a separate tab 524, 526 and 528. Each tab has a list of available assessments 530 and a calendar 532. The assessment list 530 has several fields briefly describing the assessments. As can be seen, the fields include ID, Title, Type, Duration and Grade. As will be appreciated, the duration for each assessment may be set by the teacher or left unspecified. When a teacher selects a particular assessment, such as assessment 534, the details 536 of that assessment are shown at the bottom part of the window.

The teacher may sort the list of assessments by any of the fields in either ascending or descending order by clicking the field title. In the example shown in FIG. 12b, an icon 566 is displayed to indicate that the assessments are sorted by ID, in ascending order. The teacher may also click the filtering icon 568 showing beside each field title to set up filters so that only the assessments satisfying the filter criteria will be shown in the list of assessments.

The calendar 532 shows the assessment schedule. In the example shown in FIG. 12B, the calendar 532 shows the time of a day in an hourly view. A time line 533 indicates the current time. The teacher may change the display of the calendar 532 to daily or monthly view (not shown), by using the “View” button 535.

In this embodiment, to schedule assessment 534 the teacher drags (represented by dashed arrow 538) the assessment from the assessment list 530, and drops it into a time slot 540. Assessment 534 is then scheduled to begin at Oct. 2, 2009 at 11:00 AM. Once the assessment 534 has a selected time, the title of the assessment 534 is added to the time slot 540, and the time slot 540 is highlighted between the starting time and ending time. The ending time of the assessment is determined by the duration of the assessment if the duration is specified, or by a predefined default duration if the assessment duration is not specified. The teacher may drag the upper or lower boundary of the time slot 540 to change the starting or ending time, respectively. The teacher may also drag the assessment to another time slot to change its schedule, or drag it out of the calendar to cancel it. Other operation methods (e.g., by using shortcut key combinations) are well known and can also be used here. If the class comprises remote users in different time zones, the time slot 540 is shown in the time zone of the students who will be completing the scheduled assessment 534. In the event the students are located in different time zones, a warning message will be displayed to the teacher to bring it to their attention.

By default, the “Delete after use” flag associated with each scheduled assessment is set, indicating that the assessment must be deleted from the response devices after use. In this embodiment, icon 550 represents a toggle button for the “Delete after use” flag, and as shown, it can be turned on and off by a simple click. In view of FIG. 12b, it can be seen that the “Animals” and “Integers” assessments have the “Delete after use” flag 550 turned on, and the “Essay” assessment has the “Delete after use” flag 552 turned off.

By default, each scheduled assessment is to be preloaded at the loading date/time calculated using Equation 1. In this embodiment, an icon 560 is used to indicate the status of the preloading. The teacher may click on icon 560 to set the loading date/time, or force the assessment loading to start immediately. In the event that the assessment loading is in progress, the icon 560 changes to icon 562 to indicate the change in status. Once the loading is complete, icon 562 will change to icon 564, to indicate a successful preload.

The teacher may change the preload settings by selecting the Options tab 548 on the toolbar menu. In this embodiment, selecting the Options tab 548 brings up the settings window 580 as shown in FIG. 12d. As can be seen, settings window 580 allows the teacher to set the deadline for preloading the assessments to each of the response devices 62 by entering a numerical value in window 582 (considered to be the minimum preloading overhead T₀ₘ). Similarly, the teacher can set the deadline for decrypting the assessments on each of the response devices 62 by entering a numerical value in window 584 (considered to be the minimum decryption overhead T₁ₘ). The teacher may elect for the scheduled assessment to be preloaded at low network traffic time (or times if the preloading can be done in segments of the assessment) by selecting the toggle button 586. Then, the assessment loading will start when the loading date/time is reached, and the data transmission will only occur when the network traffic is below a predefined threshold. The transmission will continue until the network traffic is higher than the threshold, and will be resumed whenever the network traffic becomes low. However, the transmission will be resumed no matter the network traffic is low or high when the time to the start of the assessment is less than the minimum preloading overhead.

Similarly, the teacher may elect for the decryption of assessments to be completed during a time of low CPU usage by selecting the toggle button 588. Similar to the above, assessment decryption only occurs when CPU usage is below a predefined threshold. However, the decryption is performed regardless the CPU usage if the time to the start of the assessment is less than the minimum decryption overhead.

The actual preloading overhead T₀ is calculated by the system based on the size of the files to be transmitted and the speed of the network, and is regularly updated with respect to the network traffic until the assessment preloading starts. First, the system calculates a possible preloading overhead T₀ₚ, as shown in Equation 3, below:

T₀ₚ=NS/R (3)

where:

N is the times that the files have to be transmitted;

S is the size of the files to be transmitted; and

R is the average network speed.

The parameter N is determined by the system design. For the participant systems that use multicasting to transmit files to all response devices 62 in the class at the same time, N=1. For the systems sequentially transmitting files to each of the response devices 62, N is the number of response devices the files have to be transmitted thereto. For the systems using multicasting with groups, N is a number between 1 and the total number of response devices in the scheduled classes. Those skilled in the art will appreciate that a more accurate N should also be based on the probability of retransmission. For example, if files are sequentially transmitted to each response device, and the probability of retransmission is equivalent to 1% probability of retransmitting all files to all devices, then, N=M (1+1%), where M is the total number of response devices to receive the files. Other calculation of the probability of retransmission may also be used to compute an accurate N.

The average network speed R is calculated from the historical data. It may be the overall average of the network speed in the past, or the average network speed in a past period (for example, over the last 10 days). In a preferred embodiment, the average network speed R is the average network speed that covers the possible loading time, and is calculated by averaging the network speed data for a particular time range of a day in a past period. For example, if the scheduled assessment time is at 3:00 PM, and the assessment has to be loaded at least 30 minutes before it starts, the possible loading time must be no later than 2:30 PM. Then, the average network speed R is the average of the network speeds sampled in the afternoon of the last 10 days.

Once T₀ₚ is calculated, the actual preloading overhead T₀ is calculated as shown in Equation 4, below:

T₀=MAX(T₀ₚ,T₀ₘ) (4)

where:

MAX( )is the maximum function.

In the event that the teacher selects toggle button 586 to indicate loading assessments at low network traffic time, the assessments will be automatically preloaded to each of the response devices 62 when the network traffic is below a predefined threshold. In the event that the assessments are being preloaded to each of the response devices 62 and the network traffic goes above the predefined threshold, the preloading will pause until the network traffic slows down below the threshold. As will be appreciated, in the event the network traffic never falls below the predefined network threshold, the preloading will be forced to ensure all required assessments are preloaded to each of the response devices 62 prior to the decryption time. The possible preloading time T₀ₚ in this case is then calculated as shown in Equation 5, below:

T₀ₚ=S/R/F_{N} (5)

where:

F_{N} is the possibility that the network traffic is below the predefined network threshold observed from historical data.

Similarly, F_{N} may be observed from all historical data, or from a time period (for example, over the last 10 days). The actual preloading overhead T₀ is then calculated using Equations 4 and 5.

As will be appreciated, the actual decryption overhead can be calculated for each response device in a similar manner as described above except where in equations (3) to (5) all subscripts “0” are now replaced by the subscript “1” to indicate decryption overhead, R now represents the average decryption speed of the response device, and F_{N} now represents the possibility of low CPU usage of the response device. In the event that the teacher selects toggle button 588 to indicate decrypting assessments at low CPU usage, the assessments will be automatically decrypted by each of the response devices 62 when the CPU usage of that particular response device 62 falls below a predefined CPU usage threshold. Since different response device may have different performance and different usage, the description overhead may be different, and in turn the actual decryption time may be different, which ensures that the decryption will be completed on all response devices at about the same time. The actual decryption overhead on each response device is regularly updated with respect to the CPU usage until the assessment decryption starts.

Turning back to FIG. 12b, icons 542, 544 and 546 are used to indicate whether the response devices have enough available storage space to load the assessment. In this embodiment, icon 542 indicates that some of the response devices 62 do not have enough storage space for loading the assessment, or their information is not available. Icon 544 indicates that all response devices 62 do not have enough storage space for loading the assessment. Icon 546 indicates that all response devices 62 have enough storage space for loading the assessment. As will be appreciated, other visual indications, as well as audio indications, may also be used to notify the teacher whether or not all response devices 62 have enough available storage.

The teacher may click on any one of the icons 542, 544 and 546 to see the detail of the file check, as shown in the Students and Devices window in FIG. 12c. The Student and Devices window shows a list of students, their assigned response device 62, the total space of that response device, the total free space on that response device, and the sufficiency of that response device (that is, whether or not that particular response device has sufficient storage to load the assessment). As can be seen, students Bob, John and Bill are assigned with response devices C5, C3, and C4, respectively. Response devices C5 and C3 have sufficient storage space to load the assessment, while response device C4 does not. Student Eric is not assigned to any particular response device, and thus he can use any available response device. Response devices C1 and C6 do not have any assigned student, and thus can be used by any student. Response device C1 has sufficient storage space to load the assessment, while response device C6 status is not available (N/A), which may be resulted from its disconnection with the teacher's computer, e.g., currently powered off.

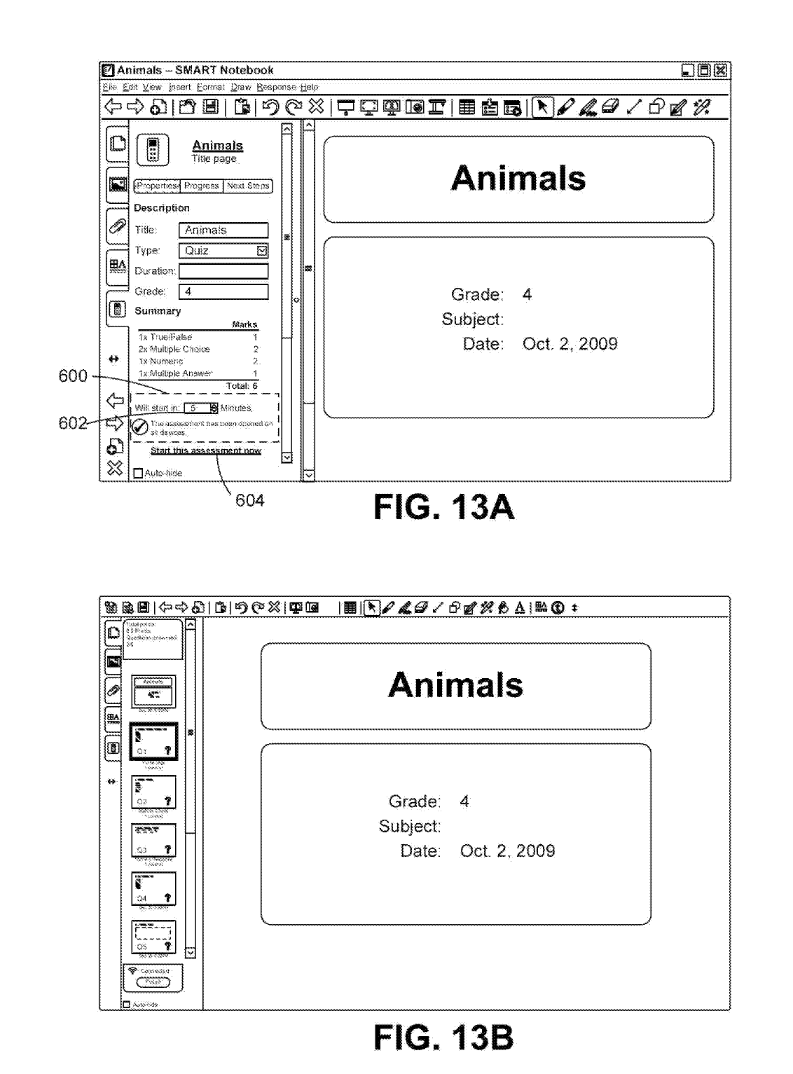

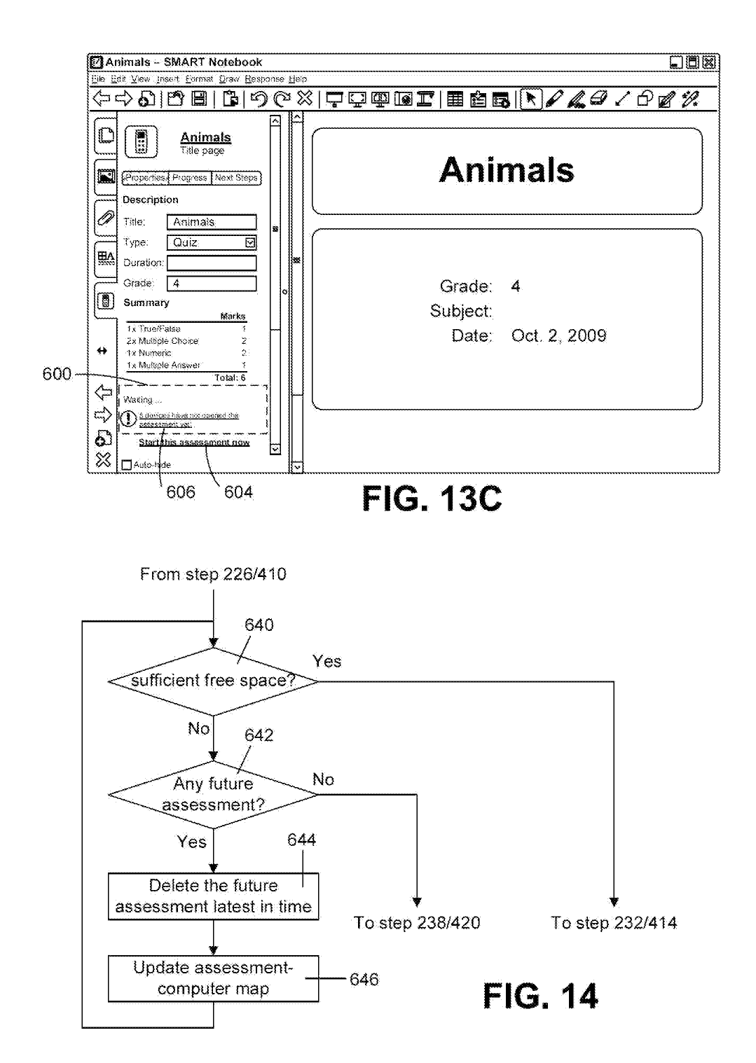

After the assessment is decrypted, the assessment client 156 on each of the response devices 62 opens the decrypted assessment and locks the assessment at the title page until the assessment begins. As previously described, the time in which the assessment begins can be automatically set, or manually prompted by the teacher. FIG. 13a shows an exemplary title page as seen by the teacher prior to the assessment beginning. FIG. 13b shows an exemplary title page as seen by a student on one of the response devices 62 prior to the assessment beginning. The view seen by the student is completely locked and all functions of the assessment client 156 are disabled until the assessment starts.

The teachers screen shown in FIG. 13a has a status area 600 with a countdown box 602 and a “Start this assessment now” link 604. The status area has an indicator showing the status of all response devices 62 that are scheduled to run the assessment. The countdown box 602 indicates how much time is left before the assessment begins. The teacher may wait the required time shown in the countdown box 602, or can click on the “Start this assessment now” link 604 to start the assessment immediately. Alternatively, the teacher can edit the countdown box 602 to change the countdown time. As will be appreciated, once the assessment begins, the countdown box 602 will begin counting the time since the assessment has started, and the “Start this assessment now” link 604 will change to a “Stop this assessment now” link, which of course, will stop the assessment when selected by the teacher.

In the event at least one of the response devices 62 scheduled to run the assessment cannot load the assessment in time, the status area 600 will indicate this to the teacher, as shown in FIG. 13c. As can be seen, the status area 600 has an alert 606 informing the teacher the total number of response devices 62 that have not loaded the assessment on time. The assessment is halted on all response devices 62, until all response devices 62 have loaded the assessment, or until the teacher clicks on the “Start the assessment now” link 604 to start the assessment regardless of the fact that not all response devices 62 have loaded the assessment.

In an alternative embodiment, the assessments may be saved on a network server having a storage module. In this embodiment, the assessments will be created by the teacher on the host computer 52, and saved on the storage module of the network server. As will be appreciated, the encryption module 150 may be on the host computer 52 or on the network server. The network module will send the assessments to each of the response devices 62 according to the assessment schedule, similar to the embodiments described previous.

In the following, several other alternative embodiments will be described based on the embodiments described above.

In a first alternative embodiment, the participant response system 50 may be configured to automatically delete any unused assessments that have been idling in storage 162 on the response device 62 for a predetermined amount of time. As will be appreciated, a similar configuration could be provided where an assessment that has been loaded onto storage 162 on one of the response devices 62, but is not scheduled to be used in the near future, could be automatically deleted from the storage 162. The deleted assessment could then be automatically preloaded back onto the storage 162 on each of the response devices from the teacher's storage 144 at a time closer to the scheduled time. As will be appreciated, the method of automatically deleting unused assessments could be employed in the event that the system 50 determines that a response device 62 does not have sufficient storage space to load a new assessment (similar to that of step 412 in FIG. 11). In this embodiment, the method described above could be employed with the steps 230 (FIG. 8C) and 412 (FIG. 11) being replaced by the process shown in FIG. 14. In the event that system 50 determines that a response device 62 does not have sufficient storage space to load a new assessment (step 640), it is determined if any future assessments exist on the storage 162 of that response device 62 (step 642). In the event that there are future assessments saved on the storage 162 of the response device 62, the system 50 will begin deleting the assessments that have been idling for a predetermined amount of time from the storage 162, starting at the assessment with the latest scheduled starting time (step 644), until there is sufficient storage space to load the new assessment, or until all assessments that have been idling for a predetermined amount of time are deleted. As will be appreciated, the system 50 then updates the assessment-computer map (step 646). The deleted assessments will be automatically loaded back onto storage 162 on the response device 62 at a later time, which of course, will be prior to the scheduled starting time.

In a second alternative embodiment, encryption is not used in preloading. Rather, each file to be transmitted is partitioned into multiple chunks. For each file, at least one chunk (the key chunk) contains necessary information of the file, without which the content of the file is meaningless or cannot be properly accessed. For example, an AVI video file comprises a header providing information regarding, e.g., the frame rate, width and height of the video stream, etc. The AVI file cannot be played if the chunk comprising the header is not available.

During the preloading of an assessment, the chunks of each file may be transmitted separately and may be received and even stored in an order different to their natural order (e.g., scrambled). Information defining the natural order of the chunks is also transmitted. Each response device assembles the received chunks in accordance with the natural order information it receives. However, a key chunk(s) is (are) not transmitted until the starting time of the assessment approaches. Thus, the assessments are effectively locked until key chunk(s) is (are) received. This embodiment is the same as the preferred embodiment except some modifications on FIGS. 8C and 11.

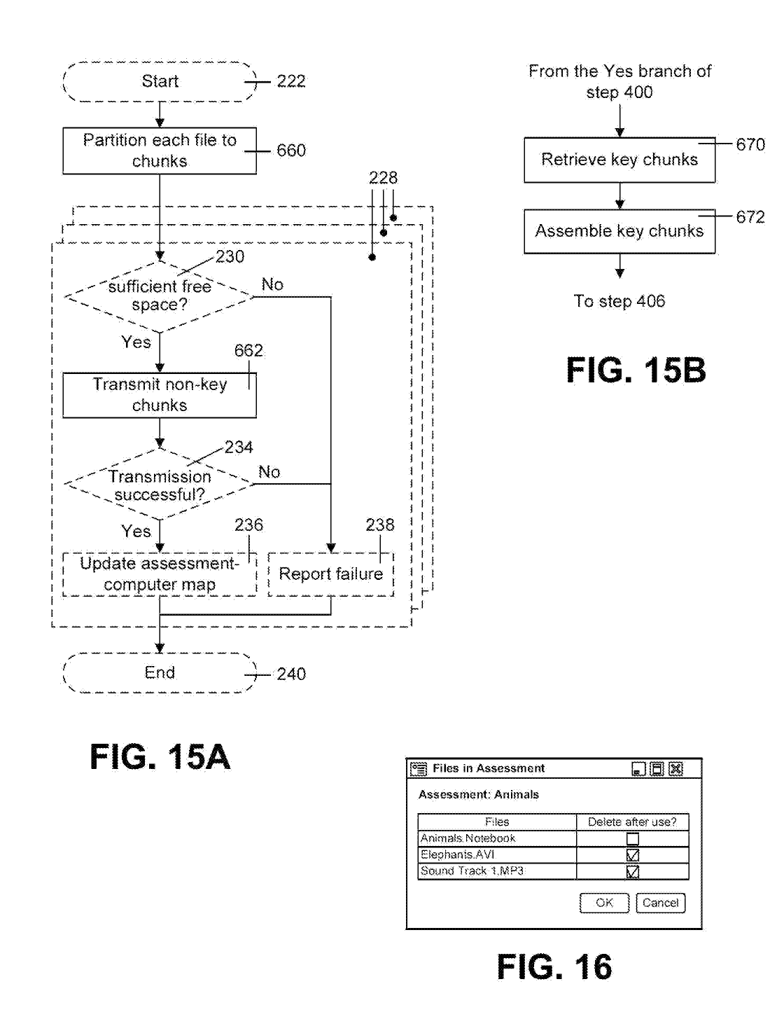

FIG. 15A shows the modified version of FIG. 8C where blocks with dashed border are the same as the corresponding blocks in FIG. 8C, and are marked with the same numerals as those in FIG. 8C. When preloading starts (step 222), the system partitions each file into chunks where at least one chunk is the key chunk (step 660). The process then goes to step 230 as in FIG. 8C. If a response device has sufficient free storage space, the chunks of each file, except the key chunk(s), are transmitted thereto (step 662). The information defining the natural order of the chunks is also transmitted to the response device at this step, and the response device assembles the received chunks according to the natural order information it received. Other steps are the same as in FIG. 8C.

FIG. 15B illustrates the modified part of FIG. 11 corresponding to steps 402 and 404. Branching from the Yes branch of step 400 as in FIG. 11, the response device retrieves the key chunks from the teacher's side (step 670). After receiving the key chunks, the response device assembles them to their corresponding files (step 672), and the process goes to step 406 as in FIG. 11.

A third alternative embodiment may be obtained by modifying the second alternative embodiment. Instead of holding the key chunks until the assessment starts, the system transmits all chunks to the response devices. However, the information of the natural order of the chunks is not transmitted until the assessment is about to start. Each response devices stores the chunks it received in an arbitrary or scrambled order, and assembles or descrambles them after they received the natural order information.

In the embodiments described above, an assessment is preloaded to response devices 62 as a whole, and is deleted as a whole if the “Delete after use” flag is set to “Yes”. In a fourth alternative embodiment, each file is preloaded independently. Each file is associated with a teacher operable “Delete after use” flag (described below), such that used files can be deleted independently. Consequently, an assessment may be partly preloaded if there is insufficient storage space in a response device for the whole assessment but may be sufficient for some files thereof. The teacher may set some files in an assessment to be deleted after use, and set other files therein to be kept after use. In this embodiment, the management module 142 maintains an assessment schedule table. Each record in the assessment schedule table maintains the GUID of a scheduled assessment, the scheduled starting time, and the classes assigned to that scheduled assessment. The management module 142 also maintains an associated file table recording the associated files for each of the scheduled assessments. Each record in the associated file table record of the file table maintains the GUID of the scheduled assessment of which the file is associated, the file ID and a “Delete after use” flag indicating whether the associated file should be deleted when the assessment is completed or if the associated file should remain in storage 162 of the response device 62. The associated file table and the assessment schedule table are linked by GUID. A GUI similar to that shown in FIG. 12b may be employed. Clicking on icon 550 opens a window 700 as shown in FIG. 16. As can be seen, the “Animals” assessment has three associated files. Each associated file has a “Delete after use” flag which can be turned on and off independently of the other associated files for that assessment.

The process of this embodiment is the same as that of the preferred embodiment except some modifications, as described below with reference to FIGS. 8C and 8D.

In this embodiment, the process illustrated in FIG. 8C is applied to every file to be transmitted. Each file is individually encrypted at step 226, and the size of the available storage space on the response device is checked at step 230 to see if the available storage space is sufficient for the file (instead of the entire assessment). The file (instead of the files of the assessment) is transmitted to the response device at step 232 if the available space is sufficient.

In step 270 of FIG. 8D, instead of deleting the assessment after use if it is no longer needed, this embodiment checks whether a used file is marked as “Delete after use”, and delete it if so.

Those skilled in the art will appreciate that the above embodiments may be combined to meet various user requirements. For example, in another alternative embodiment, assessments are encrypted, and the encrypted files are also partitioned into chunks where key chunks are held prior to the start of the assessment. In particular, each file to be transmitted is first encrypted, and then partitioned to multiple chunks. During the assessment preloading, the key chunks are not transmitted. When the assessment is about to start, each response device requests the key chunks and the decryption key. After receiving the key chunks, the response device assembles the chunks to files, and then decrypts them. In yet another alternative embodiment that combines the second and third alternative embodiments, both the key chunks and the information of the natural order of the chunks are not transmitted until the assessment is about to start.

As another example, the fourth alternative embodiment can be combined with any of the first, second and third alternative embodiments so that files are individually preloaded with encryption, holding the key chunks and/or holding the information of the natural order of chunks. Used files are deleted if their “Delete after use” tags are set. These files may be deleted after the assessment is finished. Alternatively, a file with the “Delete after use” tag being set may be deleted immediately after the student used it, or immediately after the student submitted his/her answer to the question that the file is linked thereto. If, at a later time during the assessment, the student goes back to the question that the deleted file is linked thereto, the deleted file is retransmitted from the storage 144 at the teacher's side to the student's response device.

As yet another example, the third and fourth alternative embodiments can be combined to allow the system individually preload the files associated with the scheduled assessment, and delete individual files after they are used. If the response device does not have enough free storage space at the time of loading one or more files shortly before the assessment starts (referring to FIG. 14) , the response device will find the assessment schedule at the furthest future date, and then find a file associated therewith that satisfies some criteria, and delete it. The assessment-computer map is then updated to remove the deleted file. This process is repeated until the available storage space is sufficient. Various criteria may be used to find the file to be deleted among the files associated with the assessment having the latest starting date/time, such as for example, the file with the largest size, the file with least importance, etc.

Although assessments having their “Delete after use” flag set to “no” were described as being saved on storage 162 of each response device 62, those of skill in the art will appreciate that variations are available. For example, files saved in the storage 62 of the response device 62 may be deleted if they are inactive for an extended period of time. Similarly, if the available storage space on storage 62 is insufficient for next assessment or file to be loaded, or falls below a threshold value, files that have not been opened for an extended period of time can be deleted to clear up space on storage 62 until the available storage space is above the threshold value.

Although each assessment was described as being loaded onto a response device 62 before the assessment starts, those of skill in the art will appreciate that the assessment and its associated files can be automatically loaded as the assessment progresses. For example, if the available storage space of a response device is insufficient or below the threshold, the system may load a part of the assessment that contains the first several questions or tasks, as well as the files associated therewith. Thus, when the assessment starts, the student will have some questions or tasks to work on. In this embodiment, the assessment-computer map comprises the field question ID. When a student submits her answer to a question, the files associated with the question (if there are any) are identified. Then, the system searches for these files in the assessment-computer map to determine whether they are used also in other questions of the assessment that the student has not submitted her answers. If yes, these files are kept; otherwise, they are deleted to free the space they occupied. The questions that have not been loaded to the response device are then loaded with the progress of the assessment. The deleted questions and their associated files may be re-loaded to the response device if the student goes back to it.

Although it was described that assessments and their associated files can be encrypted/decrypted together or independently, those of skill in the art will appreciate that variations are available. For example, all assessments scheduled to be completed on a particular day may be encrypted as a single file, and saved on storage 162 for each of the response devices 62. Only the part of the encrypted file relevant to the assessment to be decrypted is decrypted at the corresponding decryption time.

Although in above exemplary embodiments, a different encryption/decryption key is generated for each assessment or file, those skilled in the art will appreciate that an encryption/decryption key may be applied to all assessments or files. Alternatively, while different encryption/decryption keys are used, the same encryption/decryption key may be applied to a plurality of assessments or files that satisfy some criteria such as for example, those scheduled in the same time range, or those scheduled for the same class. For example, all assessments scheduled in the same morning will be encrypted/decrypted using the same encryption/decryption key, which is different to the key for the assessments scheduled in the afternoon or night, or in different days. Moreover, encryption/decryption keys may be different for different response devices.

Although in above exemplary embodiments, an assessment is decrypted before the assessment starts, those skilled in the art will appreciate that the assessment may be decrypted on-the-fly. For example, the files associated with an assessment are individually encrypted, and then transmitted to the response devices. When the assessment is about to start, each response device first decrypts the assessment file, and analyzes its content to determine the order that other associated files will be used. Then, the response device decrypts a subset of associated files, e.g., the files that will be used in the first several questions, and starts the assessment. The files that have not been decrypted will be decrypted during the progress of the assessment (at low CPU time, if possible). The number of questions to be decrypted before the assessment starts may be adjusted by the teacher in the system settings.

This method may be suitable for the case where some students turn on their response devices and log in to the class just before the assessment starts. With this method, these students only have to wait for a short time until the first question or first contiguous set of questions, as well as the files associated therewith, are decrypted. A substantial amount of time for these students would thus be saved by allowing them to begin answering questions sooner so they do not lose time to other students.

Although in some of the above exemplary embodiments, the storage 144 and 162, respectively, are non-volatile storage containing a file system where the assessments are stored in the storage as one or more files, those skilled in the art will appreciate that the storage 144 and 162, respectively, may be volatile memories, or may be local databases (i.e., in the teacher's computer and in response devices, respectively) and/or databases distributed in the network/Internet, where each assessment is stored in the database as a record or a set of related records. Similarly, some assessments may share the same records. Alternatively, the storage 144 and 162, respectively, may be mixture of database and file system, where some assessment content (e.g., questions) is stored in the database and other assessment content (e.g., audio/video clips associated to assessments) is stored as files in the file system.

Although in above exemplary embodiments, assessments are decrypted shortly before they start, those skilled in the art will appreciate that some assessments (e.g., home-work and self-paced quizzes) may be decrypted immediately after they are received and stored in the storage 162 in unencrypted forms. Some assessments may be preloaded to response devices without encryption. Moreover, whether an assessment would be preloaded with or without encryption may be based on the classes or response devices that the assessment to be preloaded thereto.

Although in above exemplary embodiments, the decryption key is retrieved after the response devices sent request to the teacher's side, those skilled in the art will appreciated that, when the decryption time of an assessment approaches, the controller 148 may send the assessment's GUID and its decryption key to the response devices without a request.

Although it was described that the decryption key is retrieved by each response device 62 communicating with the host computer 52, the decryption key can be send to each response 62 and saved in storage 162, where it can be retrieved by the decryption module 160 when needed. If the decryption module 160 tried to retrieve the decryption key from storage 162 unsuccessfully, it can prompt the host computer 52 to resend the decryption key for immediate use.

Although each student was described as being associated with a similar set of metadata, conditions for a particular student or the response device associated to that particular student may be set. For example, the particular student may require the text of the assessment be a larger size than the other students. The management tool 142 would provide functionality to the teacher to set up rules for each assessment, student, and response device.

Although it was described that each assessment has a “Delete after use” flag, it will be appreciated that other teacher operable delete conditions are available. For example, an assessment may be automatically deleted from each response device 62 one week after it is used. An assessment may be automatically deleted from a response device 62 after the student reviewed it. Also, assessments may be automatically deleted from each response device 62 at the end of a semester.

Although the assessments were described as being managed by an assessment-computer map, it will be appreciated that other indexing engines may be implemented providing more functionalities for the assessment schedule. For example, an indexing engine having advanced search functionality may be implemented.

Although the encryption module was described as only encrypting the content of the assessments and their associated files, it will be appreciated that other information related to the assessments and their associated files can also be encrypted. For example, the names of assessments as well as the names of the associated files can be masked on the storage 162 of each response device 62 so the student would not be able to identify which files on the storage 162 contain assessments. Similarly, the files may be hidden on the response device and would only be viewable at a predetermined time.

Although in above exemplary embodiments, the transmission is considered failed if a response device 62 doe not have sufficient storage space for the necessary files of the assessment (see FIG. 8c), in some alternative embodiments, the transmission may be considered failed if a response device 62 doe not have sufficient storage space for all files, including optional files, of the assessment.

Although in above exemplary embodiments, files and applications associated with an assessment are determined by the teacher at the time the teacher composes/revises the assessment, those skilled in the art will appreciate that some files and/or applications may be automatically associated with an assessment based on each student's characteristics according to predefined rules. For example, in yet another embodiment, each student is associated with a set of metadata describing the characteristics of the student, e.g., the student's grade, the native language the student speaks, the special needs (e.g., large fonts, high contrast, or special color scheme for read-green blindness), etc. The management tool 142 allows the teacher to set up rules to automatically associate files and/or application to students having particular metadata for some assessments. For example, the teacher may set up a rule such that an English-French dictionary application is associated with students whose native language is French for all assessments except English language tests. Thus, in any assessment other than English tests, the English-French dictionary application will be automatically launched on the response devices that these students are using.

Although embodiments have been described above with reference to the accompanying drawings, those of skill in the art will appreciate that variations and modifications may be made without departing from the spirit and scope thereof as defined by the appended claims.

What is claimed is:

1. A method of using an assessment in a participant response system having a plurality of response devices, the method comprising:
locking an assessment portion to be loaded to create a locked assessment portion;
transmitting the locked assessment portion to each response device for storage in each response device;
unlocking the assessment portion on each response device at a time prior to a scheduled start time thereby to enable access to the assessment portion; and
starting the assessment portion on each response device at the scheduled start time.

2. The method of claim 1 further comprising:
prior to the transmitting, checking each response device to determine if the response device has sufficient storage space for storing the locked assessment portion.

3. The method of claim 2 further comprising:
in the event a response device does not have sufficient storage space, reporting a failure.

4. The method of claim 1 wherein the unlocking is executed on each response device when CPU usage for the respective response device is below a predetermined CPU threshold.

5. The method of claims 1 wherein the transmitting is executed when network traffic is below a predetermined network threshold.

6. The method of claims 1 wherein the locking is executed on one of a host computer and a network server.

7. The method of claim 1 wherein the transmitting is executed on one of a host computer and a network server.

8. A participant response system comprising:
at least one host computer having host processing structure configured to lock a portion of an assessment creating a locked assessment portion; and
a plurality of response devices communicating with the at least one host computer, each of the response devices having response processing structure configured to receive the locked assessment portion, unlock the locked assessment portion at a time prior to a scheduled start time, and start the assessment portion at the scheduled start time.

9. The participant response system according to claim 8 wherein the host processing structure is configured to determine if each response device has sufficient storage space for storing the locked assessment portion.

10. The participant response system according to claim 9 wherein the host processing structure is configured to, in the event the response device does not have sufficient storage space, report a failure.

11. The participant response system according to claim wherein the response processing structure is configured to unlock the locked assessment portion when the CPU usage of the response device is below a predetermined CPU threshold.

12. The participant response system according to claim 8 wherein the host processing structure is configured to transmit the locked assessment portion when network traffic is below a predetermined network threshold.

13. The participant response system according to claim 8 wherein the host processing structure is executed on one of a host computer and a network server.

14. The participant response system according to claim 8, wherein the transmitting is executed on one of a host computer and a network server.
